(19) United States
(12) Patent Application Publication
(10) Pub. No.: US 2013/0313923 A1
(43) Pub. Date: Nov. 28, 2013

(54) THERMALLY CONDUCTIVE COATING FOR PERMANENT MAGNETS IN ELECTRIC MACHINE

(71) Applicant: REMY TECHNOLOGIES, LLC, Pendleton, IN (US)

(72) Inventors: Colin Hamer, Noblesville, IN (US); Brad Chamberlin, Pendleton, IN (US)

(73) Assignee: Remy Technologies, LLC, Pendleton, IN (US)

(21) Appl. No.: 13/763,109

(22) Filed: Feb. 8, 2013

Related U.S. Application Data
(60) Provisional application No. 61/650,614, filed on May 23, 2012.

(51) Int. Cl. H02K 9/22; H02K 15/02

(52) U.S. Cl. CPC H02K 9/22; H02K 15/024
USPC 310/45; 29/598

(57) ABSTRACT

A method of manufacturing an electric machine that includes providing a core defining a slot, coating a magnet body prior to installation of the magnet body into the slot and installing the magnet body into the slot wherein the coating on the magnet body has a thermal conductivity of at least about 0.3 W·m⁻¹·K⁻¹, advantageously of at least about 0.5 W·m⁻¹·K⁻¹, and even more advantageously of at least about 2 or 3 W·m⁻¹·K⁻¹ and wherein the coating is in a partially cured condition when the magnet body is inserted into the slot. The coating may form a substantially voidless material bridge between the magnet body and the core over at least a portion of the magnet body and thereby thermally couple the magnet body with the core. An electric machine manufactured in accordance with the method is also disclosed.

### CROSS REFERENCE TO RELATED APPLICATIONS

This application claims priority under 35 U.S.C. 119(e) of U.S. provisional patent application Ser. No. 61/650,614 filed on May 23, 2012 entitled THERMALLY CONDUCTIVE COATING FOR PERMANENT MAGNETS IN ELECTRIC MACHINE the disclosure of which is hereby incorporated herein by reference.

### BACKGROUND

The present invention relates to electrical machines such as motors and generators. More particularly, the present invention relates to electrical machines employing permanent magnets.

The two main components of an electric machine are the stator and the rotor. One common type of electric machine employs a rotor having permanent magnets. Such permanent magnet electric machines can be operated as a motor to convert electrical power into mechanical power or as a generator to convert mechanical power into electrical power.

In some applications, the electric machine may be operated exclusively as a motor while in other applications the electric machine may be operated exclusively as a generator. In still other applications, the electrical machine may be selectively operated as either a motor or as a generator.

Electric machines having permanent magnets may be employed in a wide variety of applications. For example, such electric machines may be employed in hybrid electric vehicles and can be operated as a generator when the vehicle is braking and as a motor when the vehicle is accelerating. Other applications may employ such electrical machines exclusively as motors, for example, as motors which power different components of construction and agricultural equipment. Other uses may employ such motors exclusively as a generator such as in a portable generator for residential use. Those having ordinary skill in the art will recognize that electric machines having permanent magnets can also be utilized in a large and varied number of applications beyond those few mentioned here.

The rotors of such electrical machines are commonly manufactured by stamping and stacking a large number of sheet metal laminations. In one common form, these rotors are provided with axially extending slots for receiving the permanent magnets. In still other forms of electric machines, the stator assembly may include permanent magnets.

While many electric machine employing permanent magnets operate at high efficiencies, some energy is necessarily lost. Such energy losses take various forms including friction losses, core losses and hysteresis losses and result in the generation of waste heat. When permanent magnets are subjected to heat and electrical fields, they may lose their magnetism. Generally, such magnets will have an upper temperature limit at which they will lose magnetism at minimal electric field strength. As the electrical field strength increases, the temperature at which the permanent magnets will lose magnetism decreases. In other words, as the current through the electric machine increases, the temperature at which the permanent magnets will lose magnetism decreases. Of course, such a loss of magnetism has a negative impact on the performance of the electric machine.

Many known electric machine designs actively remove heat from the electric machine to limit the temperature of the electric machine during operation. Typically, the removal of heat from the electric machine is done to prevent the stator windings of the electric machine from reaching impermissibly high temperatures.

Known methods of removing heat from electric machines include spray cooling, which typically involves spraying oil on the end turns of the windings to remove heat from the electric machine. It is also known to provide the electric machine with a “water jacket” taking the form of a housing with fluid passages through which a cooling liquid, such as water, may be circulated to remove heat from the electric machine. It is also known to provide air flow, which may be assisted with a fan, through or across the electric machine to promote cooling.

An improved electric machine design which inhibits the loss of magnetism in permanent magnets is desired.

### SUMMARY

The present invention provides an electric machine having permanent magnets in which the transfer of heat from the permanent magnets is enhanced to thereby inhibit the loss of magnetism in the permanent magnets.

One embodiment comprises a method of manufacturing an electric machine that includes providing a core defining a slot and applying a coating having a thermal conductivity of at least about 0.3 W·m⁻¹·K⁻¹ to at least a portion of a magnet body. The magnet body is then inserted into the slot while the coating is in a partially cured condition. For example, the coating may be a B-stage epoxy when the magnet body is inserted into the slot.

In some embodiments of the method, the magnet body defines at least one major surface and the coating forms a substantially voidless material bridge between the at least one major surface and the core and thereby thermally couples the magnet body with the core.

In yet other embodiments of the method, the magnet body defines first and second major surfaces on opposing sides of the magnet body and the coating forms a substantially voidless material bridge between the core and both of the first and second major surfaces.

In still other embodiments, the method includes the step of magnetizing the magnet body after inserting the magnet body into the slot. The step of magnetizing the magnet body biases a first major surface of the magnet body toward a first slot surface defined by the core by magnetic attraction with the coating forming a substantially voidless material bridge between the first major surface and the slot surface to thereby thermally couple the magnet body with the core.

In some embodiments, the method includes heating the core and inserting the magnet body into the slot before allowing the core to cool whereby the coating on the magnet body is heated to reflow the coating during the insertion of the magnet body and cooling of the core.

Another embodiment comprises an electric machine that includes a stator assembly and a rotor assembly. At least one of the stator assembly and the rotor assembly including a core defining a slot. A magnet body defining a first major surface is disposed in the slot and a coating adhesively secures the magnet body to the core wherein the coating forms a substantially voidless material bridge between the first major surface of the magnet body and the core and has a thermal conductivity of at least about 0.3 W·m⁻¹·K⁻¹.

In alternative variants of the various embodiments of the invention, the coating material may advantageously have a thermal conductivity of at least 0.5 W·m⁻¹·K⁻¹, and even more advantageously, of at least about 2 W·m⁻¹·K⁻¹ or at least about 3 W·m⁻¹·K⁻¹.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a schematic cross sectional view of a permanent magnet.

FIG. 2 is an exploded perspective view of a rotor and permanent magnets.

FIG. 3 is a schematic cross sectional view of an electric machine.

FIG. 4 is a schematic top view of a permanent magnet installed in a rotor slot.

FIG. 5 is a schematic top view of a magnetizer and an alternative permanent magnet installed in a rotor slot.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

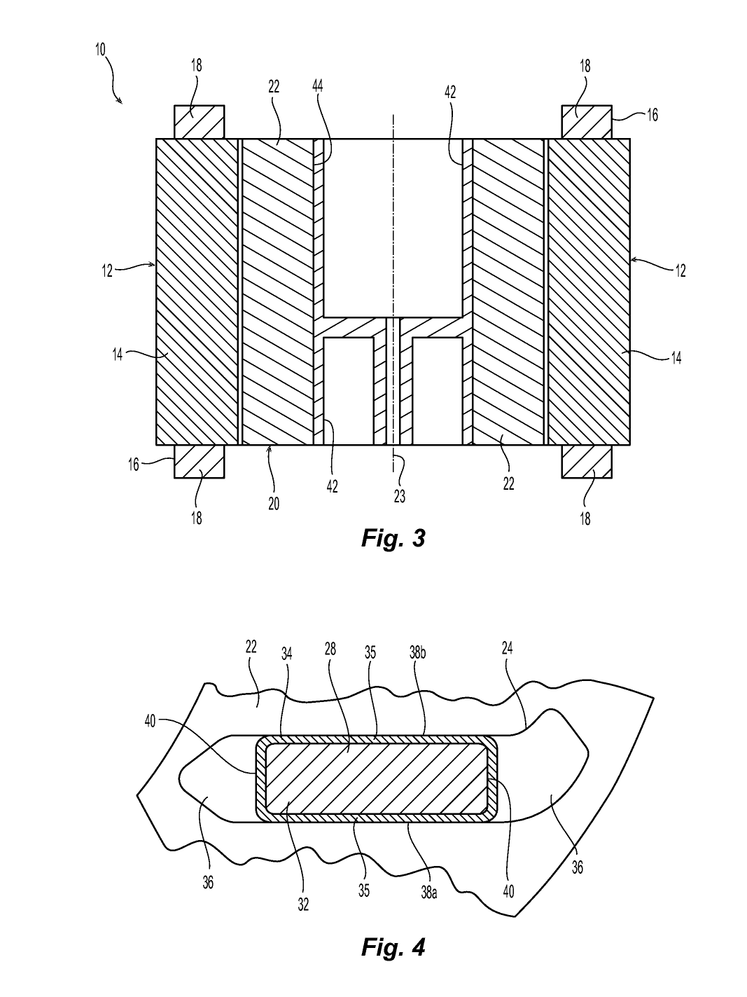

An electric machine 10 is schematically depicted in FIG. 3 and includes a stator assembly 12 having a stator core 14 and windings 16. Stator core 14 is formed out of a plurality of stacked sheet metal laminations and has a generally cylindrical shape with a central bore for receiving rotor assembly 20. Windings 16 which extend the axial length of stator core 14 and have end turns 18 projecting axially beyond stator core 14.

Rotor assembly 20 includes a rotor core 22 formed out of a plurality of stacked sheet metal laminations 21 and rotates about axis 23. Rotor core 22 has a central bore 44 and a plurality of axially extending slots 24, 26. Permanent magnets 28, 30 are installed in slots 24, 26. As can be seen in FIG. 2, the illustrated stator core 22 has a plurality of large slots 24 and a plurality of small slots 26 into which large magnets 28 and small magnets 30 are respectively installed. Although it is conventional to utilize a stator which surrounds the rotor, alternative embodiments of the electric machine may employ a central stator and a rotor that surrounds the stator. Moreover, various other known design modifications may also be made to electric machines employing permanent magnets when employing the teachings of the present application.

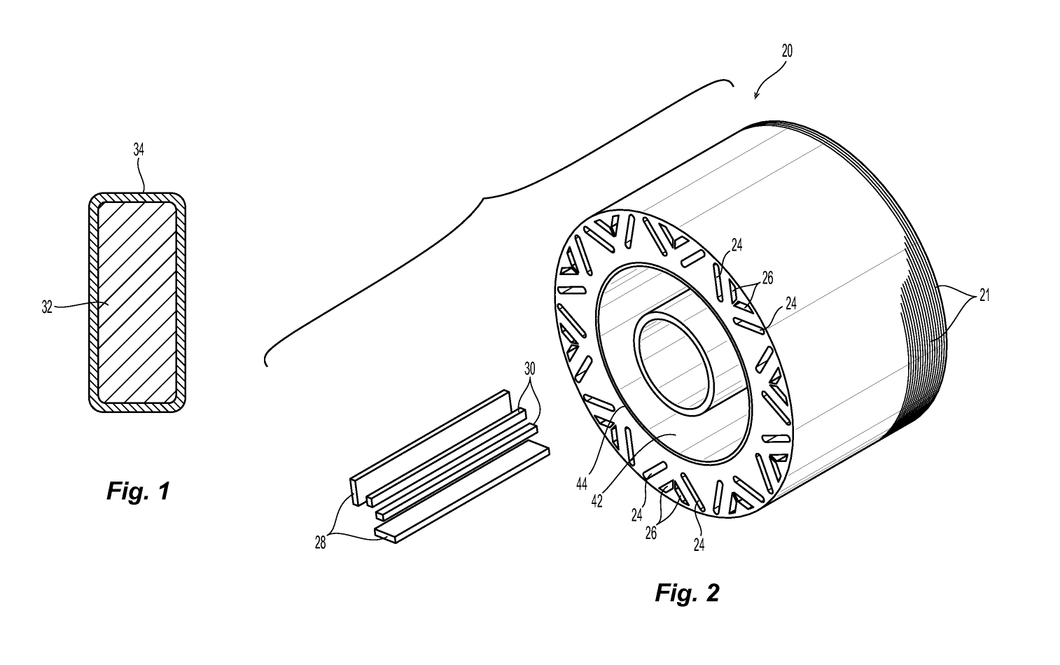

FIG. 1 presents a schematic cross sectional view of one of the larger magnets 28. Small magnets 30 have a common design with large magnets 28 with the only difference in the illustrated magnets 28, 30 being the dimensions of the two different sized magnets. The magnets 28, 30 all have a magnetic body 32 and an outer coating 34. It is noted that thickness of outer coating 34 is greatly exaggerated relative to the size of magnet body 32 in FIG. 1 for purposes of graphical clarity.

The magnetic body 32 of each of the magnets 28, 30 is made of a material that is capable of acting as a permanent magnet when installed in rotor core 22. The magnetic body 32 may either be magnetized prior to installation in rotor core 22 or may be non-magnetized when installed and have magnetic properties imparted to it after installation in rotor core 22.

Magnetic body 32 may be advantageously formed out of neodymium iron boron. Dysprosium may be included when forming magnetic body 32 to provide greater temperature stability and allow the magnetic material to better resist the loss of magnetism. A variety of other materials may also be used to form magnetic body 32 including rare earth materials such as lithium, terbium and samarium. The use of these and other magnetic materials to form permanent magnets for use in electric machines is well-known to those having ordinary skill in the art.

Magnetic bodies 32 may also include an intermediate layer of material such as a layer of nickel formed on the magnetic material by electroplating or a layer of aluminum formed by vapor diffusion that is located between the magnetic material and outer coating 34. Such intermediate layers of material can be used to enhance resistance to corrosion.

Magnetic bodies 32 are provided with an outer coating 34 prior to installation of magnets 28, 30 into rotor slots 24, 26. Outer coating 34 is a thermally conductive bondable coating that enhances the transfer of heat from magnetic bodies 32 to rotor core 22. By providing an outer coating 34 that forms a substantially voidless material bridge 35 between each magnet body 32 and rotor core 22 over at least one major surface of magnetic body 32, the outer coating 34 thermally couples magnet bodies 32 with rotor core 22 and enhances the transfer of heat from magnet bodies 32 to rotor core 22. The material used to form outer coating 34 has a thermal conductivity of at least about 0.3 W·m⁻¹·K⁻¹ and advantageously of at least about 0.5 W·m⁻¹·K⁻¹. Coating magnet bodies 32 with outer coating 34 prior to installation in rotor slots 24, 26 facilitates the formation of a substantially voidless material bridge 35 between magnet bodies 32 and rotor core 22. In other words, providing outer coating 34 prior to installation helps to completely fill the gap between magnet bodies 32 and rotor core 22 along the surfaces of magnet body 32 which are engaged with rotor core 22 with the material of outer coating 34. Along such surfaces, only minimal air pockets in outer coating 34 are located between magnet bodies 32 and rotor core 22.

In the illustrated embodiments, magnet bodies 32 all have a generally rectilinear cross section with first and second major surfaces 38a, 38b and edge surfaces 40 running the length of the magnet bodies. Alternative magnet body configurations, however, may also be used with the present invention. In the embodiment illustrated in FIG. 4, magnet body 32 has dimensions such that the distance between surfaces 38a, 38b closely conforms to the width of slot 24 and coating 34 forms a substantially voidless material bridge 35 between rotor core 22 and both major surfaces 38a, 38b. In this embodiment, even though outer coating 34 on edges surfaces 40 does not engage rotor core 22, a substantial majority of the surface area of the magnet body 32 is formed by major surfaces 38a, 38b at which a thermally conductive voidless material bridge is formed between magnet body 32 and rotor core 22.

Retention of magnets 28, 30 within slots 24, 26 may be provided by the mechanical engagement of rotor core 22 with magnets 28, 30. Outer coating 34, however, advantageously has adhesive properties whereby magnets 28, 30 are either partially or entirely secured within slots 24, 26 by the adhesive bond provided by coating 34. When outer coating 34 is formed out of a dielectric material, outer coating 34 also helps to prevent shorting between the individual laminations forming rotor core 22.

FIG. 4 provides an enlarged view of a magnet 28 installed in a rotor slot 24. As can be seen in FIG. 4, magnets 28 do not entirely fill slots 24 with slots 24 having end areas 36 which are not filled by magnets 28. Slots 26 have similar open end areas. End areas 36 are configured to influence the magnetic field and the configuration of such end areas to influence magnetic fields in electric machines is well-known to those having ordinary skill in the art. It is also noted that while the illustrated slots 24, 26 have closed ends, it also possible to for the slots to be open-ended with one of the end areas 36 intersecting the outer perimeter of rotor core 22 and thereby forming an axially extending opening on the outer perimeter of rotor core 22.

As mentioned above, magnet 28 shown in FIG. 4 has a generally rectilinear shape with two major surfaces 38a, 38b positioned closely adjacent to a surface of rotor core 22 and two smaller edge surfaces 40 facing end areas 36. Outer coating 34 forms a substantially voidless material bridge 35 between surfaces 38a, 38b and rotor core 22. Although outer coating 34 on edge surfaces 40 does not engage rotor core 22 a substantial majority of the surface area of magnets 28 is formed by surfaces 38 where outer coating 34 facilitates the transfer of heat from magnet 28 to rotor core 22. Although the embodiment shown in FIG. 4 has coating material 34 applied to edge surfaces 40 in addition to major surfaces 38a, 38b, the coating 34 present on edge surfaces 40 is not necessary and can be omitted.

In some embodiments, it may be undesirable for end areas 36 of rotor slots to remain open. For example, in oil cooled electric machines, if end areas 36 remain open, oil can collect in some of the end areas 36 and unbalance the rotor. Thus, although not necessary, it will sometimes be desirable to fill end areas 36. Nylon materials may advantageously be used to fill end areas 36, e.g., by injection molding. Nylon materials are available which are dielectric and will remain stable throughout the anticipated temperature range for most electric machines, e.g., between −40° C. and 180° C.

Maintaining the temperature of magnet bodies 32 within an acceptable range is facilitated by the transfer of heat from magnet bodies 32 to rotor core 22. Rotor core 22 may act as both a heat sink and as a heat conduit shedding excess heat. Many electric machines include heat removal features which cool the rotor core. For example, oil may be splashed on the electric machine to absorb and remove heat, an exterior housing of the electric machine may include fluid passages for circulating a coolant or a blower may be employed to blow air across the electric machine. In such electric machines, rotor core 22 will not only act as a heat sink absorbing excess heat from magnet bodies 32 but will also shed excess heat through the heat removal features of the electric machine.

As mentioned above, if magnet bodies 32 experience excessive heat, they may lose their magnetism. For example, some magnetic materials will demagnetize at about 320° C. in the absence of external electromagnetic fields. When electric machine 10 experiences an electrical current, the temperature at which magnet bodies 32 will demagnetize decreases. For example, when electric machine 10 experiences about 600 ampere-turns, the temperature at which demagnetization occurs may drop to about 180° C.

The installation of magnets 28, 30 into rotor core 22 will now be described. Various materials may be used to form outer coating 34. For example, an inorganic epoxy material may be used. Epoxy materials are commercially available with a thermal conductivity of about 0.3 W·m⁻¹·K⁻¹ and high thermal conductivity epoxy with thermal conductivities of 0.5 to about 0.6 W·m⁻¹·K⁻¹ are also commercially available. Moreover, various additives may be used with such epoxies to further increase the thermal conductivity of the epoxy. Such additives include boron nitride (thermal conductivity 55 W·m⁻¹·K⁻¹), aluminum oxide (thermal conductivity 33 W·m⁻¹·K⁻¹), beryllium oxide (thermal conductivity 251 W·m⁻¹·K⁻¹) and aluminum nitride (thermal conductivity 117 W·m^{'11}·K⁻¹). The use of such additives may increase the thermal conductivity of the epoxy to about 2 or 3 W·m¹·K⁻¹. Materials other than epoxies may alternatively be used to form outer coating 34, for example, silicone elastomers. Alternative additives may also be used to allow for the curing of the outer coating 34 by UV radiation, solvents or other means.

The outer coating 34 is applied to magnet body 32 prior to installation of the magnet body 32 into a slot. When using an epoxy coating, the outer coating 34 can be applied to magnet body 32 by various means such as dipping, powder coating or application of a film. The clearance between magnet surfaces 38a, 38b and rotor core 22 in the embodiment of FIG. 4 is approximately 0.1 mm or 4/1000 inch and outer coating 34 has a thickness that is equal or slightly greater than this gap.

To install magnets 28, 30 in slots 24, 26, rotor core 22 is heated to expand the size of slots 24, 26, e.g., to about 300° C. Alternatively, or additionally, magnets 28, 30 can be frozen to reduce their size and facilitate the insertion of magnets 28, 30 into slots 24, 26. Once the temperature of the rotor core 22 and magnets 28, 30 has equalized, the magnets 28, 30 will be firmly secured within slots 24, 26. In this regard it is noted that it common for rotor cores to be heated to provide for the installation of a rotor hub 42 into the central bore 44 of the rotor core. The rotor hub 42 may also be frozen to further facilitate the installation of hub 42. The installation of magnets 28, 30 can be efficiently achieved by installing magnets 28, 30 in slots 24, 26 when rotor core 22 is heated for installation of rotor hub 42.

As mentioned above, additives can be used with an epoxy material to increase the thermal conductivity of the outer coating 34. Such additives will generally allow outer coating 34 to retain its dielectric properties but will tend to increase the viscosity of outer coating 34. Increased viscosity lessens the flowability of the reheated outer coating 34 which is undesirable because it makes it more difficult for the outer coating to fully fill the gap between magnet body 32 and rotor core 22. The prior coating of magnet body 32 with outer coating 34, however, lessens the difficulties encountered by such an increase in viscosity. In comparison, if magnet bodies 32 were first inserted into the rotor slots and then coating 34 were injected into the gaps between magnet body 32 and rotor core 22, the increase in viscosity would present a more significant obstacle to providing a voidless material bridge between magnet body 32 and rotor core 22. Moreover, the small size of the gap could interfere with the introduction of additive particles into the gap between the magnetic body 32 and rotor core 22 and the uniform dispersal of particulate additives would be difficult to achieve if the outer coating were injected into the slot after insertion of magnet body 32.

When installing magnets 28, 30 in a heated rotor core 22, having an epoxy outer coating 34, the outer coating 34 may advantageously be a B-stage epoxy. It is noted that it common to refer to A-stage, B-stage and C-stage thermosetting resins wherein A-stage refers to an early stage in the reaction of the thermosetting resin during which the resin is fusible and soluble in certain liquids; B-stage refers an intermediate stage in the reaction wherein the resin softens when heated and swells when in contact with certain liquids but may not entirely fuse or dissolve; and C-stage refers to the final stage of the reaction wherein the resin is fully-cured and is relatively insoluble and infusible. The heat of the rotor core 22 advantageously softens the outer coating 34 after insertion into the rotor slot and allows the outer coating to flow and fully fill the gap between major surfaces 38 and the lamination edges forming the slot in rotor core 22 and facing surfaces 38. Alternatively, additional heat may be introduced to soften outer coating 34. In other words, heat, whether from an external source or from rotor core 22 is advantageously used to reflow outer coating 34. The outer coating is then allowed to fully cure, i.e., enter C-stage, and thereby bond magnet body 32 to rotor core 22 and provide a means for transferring thermal energy from the magnet body 32 to rotor core 22.

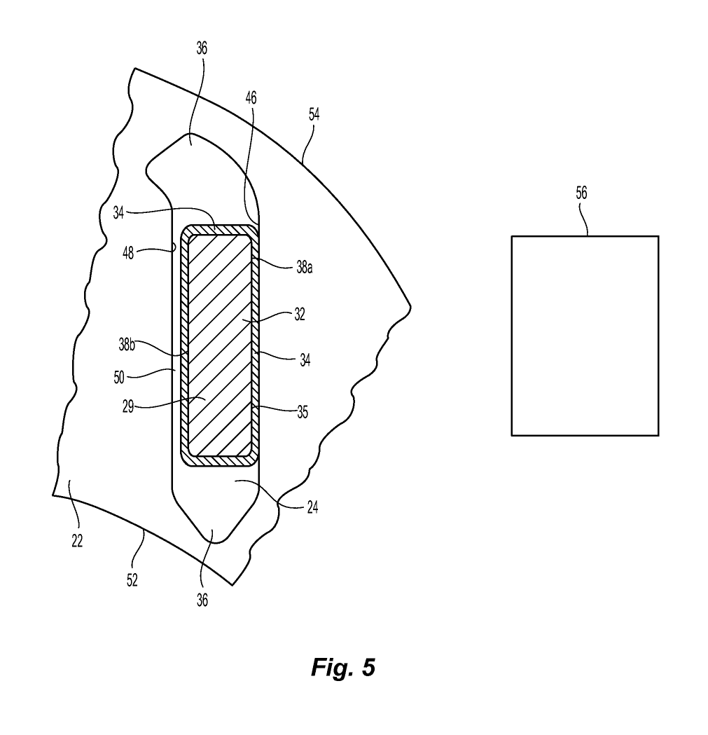

An alternative embodiment is best understood with reference to FIG. 5. This embodiment differs from the embodiment shown in FIG. 4 in that magnet body 29 in FIG. 5 is thinner than magnet body 28 in FIG. 4. In other words, the distance between the opposing major surfaces 38a, 38b of magnet body 29 (FIG. 5) is smaller than that of magnet body 28 (FIG. 4). In the embodiment depicted in FIG. 5, magnet body 29 is adhesively secured in slot 24 by the material bridge 35 formed by coating 34 between first major surface 38a and first surface 46 of slot 24.

As can be seen in FIG. 5, the interior surfaces of slot 24 include a first surface 46 which faces first major surface 38a of magnet body 29 and a second surface 48 which faces second major surface 38b of magnet body 39. Because of the thinner cross section of magnet body 29, magnet body 29 is not mechanically secured between opposing slot surfaces 46, 48 like magnet body 28. As mentioned above, magnet body 29 is, instead, adhesively secured to first slot surface 46. In this regard, it is noted that in FIG. 5, rotor core 22 defines a radially outer perimeter 54 and a radially inner perimeter 52 with first slot surface 46 being positioned closer to radially outer perimeter 54 than second slot surface 48. It is generally desirable to position permanent magnets as close to the stator assembly as possible which typically means at the most practical outwardly radial distance from axis 23. Thus, when a permanent magnet is positioned in rotor slot 24, it will generally be desirable to position the magnet as close to first slot surface 46 as practical instead of slot surface 48 because slot surface 46 is positioned radially outwardly of slot surface 48.

It is noted that between second major surface 38b and second slot surface 48 a layer 50 is disposed between magnet body 29 and rotor core 22 which has a thermal conductivity that is less than the thermal conductivity of the substantially voidless material bridge 35 formed between first major surface 38a and first slot surface 46. FIG. 5 illustrates an example wherein layer 50 is formed by a gap between coating 34 on second major surface 38b and slot surface 48. This gap may be left open, in which case the air layer between surfaces 38b and 48 will have a lower thermal conductivity than material bridge 35. Alternatively, if the end sections 36 of slot 24 are filled with a nylon or other filler material, the filler material may also be used to fill the gap and form a layer 50. Such fillers will typically have a lower thermal conductivity than material bridge 35. In still other embodiments, coating 34 may substantially fill the space between magnet body 29 and slot surface 48 but without forming a substantially voidless material bridge. In other words, the coating material may form a layer 50 having small air pockets therein which, as a result, will form a layer 50 between surface 38b of magnet body 29 and slot surface 48 which has a thermal conductivity that is less than a layer of coating material which is substantially free of air pockets, e.g., material bridge 35. It is also noted that in some embodiments it may be advantageous to apply a coating 34 to only the first major surface 38a of magnet body 29.

In the embodiment illustrated in FIG. 5, magnetizer 56 facilitates the installation of magnet body 29. Magnetizers, such as schematically depicted magnetizer 56, are well-known to those having ordinary skill in the art and can be used to impart magnetic properties to a permanent magnet after installation in a rotor core 22. Examples of magnetizers are described in U.S. Pub. No. 2009/0009012 A1 and U.S. Pat. No. 8,225,497 B2 the disclosures of which are both incorporated herein by reference.

When employed with the embodiment illustrated in FIG. 5, it is advantageous to use magnetizer 56 to magnetize magnet bodies 29 shortly after magnet bodies 29 have been inserted into slots 24 and before coating 34 has fully cured. This will allow magnetizer 56 to exert a magnetic force on magnet body 29 and thereby bias first major surface 38a toward the radially outer first slot surface 46 before coating 34 has fully cured. In this manner, the magnetic forces imparted by magnetizer 56 on magnet body 29 during the magnetization of magnet body 29 can be utilized to press magnet body 29 against slot surface 46 and thereby facilitate the removal of air pockets between first major surface 38a and slot surface 46. This biasing force exerted by the operation of magnetizer 56 also facilitates the adhesive securement of magnet body 29 to first slot surface 46 when coating 34 is an adhesive coating and the material bridge 35 between first major surface 38a and first slot surface 46 is being relied upon to adhesively secure magnet body 29 within slot 24 upon the complete curing of coating 34.

With regard to the relative merits of the embodiments of FIGS. 4 and 5, it is noted that the embodiment of FIG. 5 provides a substantially voidless material bridge of a highly thermally conductive material between only one major surface of the magnet body and the rotor core while the embodiment of FIG. 4 provides such a material bridge between two major surfaces of the magnet body and the rotor core. Thus, the embodiment of FIG. 4 will generally provide greater heat transfer from the magnet body to the rotor core than the embodiment of FIG. 5. The embodiment of FIG. 5, however, will generally be more easily manufactured because the dimensions of the rotor slot and magnet body will not need to be held to as tight a tolerance and because the magnet bodies will be more easily inserted into the core slots. In some applications, the greater heat transfer afforded by the embodiment of FIG. 4 will justify the increased manufacturing costs. For other applications, however, the heat transfer provided by the embodiment of FIG. 5 will be sufficient and the manufacturing efficiencies obtainable with this design will be desirable.

It is also noted that while FIGS. 4 and 5 each disclose only a single slot 24 of the rotor core 22, magnet bodies will be similarly inserted into a plurality of such slots in the rotor core as is best understood with reference to FIG. 2. Moreover, while it will generally be desirable to utilize a similar magnet insertion technique for each of the plurality of magnet slots in rotor core 22, e.g., use the technique exemplified by either FIG. 4 or FIG. 5 in each of the slots 24, 26 of rotor core 22, in some circumstances, it may prove desirable to install magnets in the rotor core using a combination of different techniques.

While an exemplary embodiment has been described, these teachings may be further modified within the spirit and scope of this disclosure. This application is therefore intended to cover any variations, uses, or adaptations of the invention using its general principles.

What is claimed is:

1. A method of manufacturing an electric machine comprising:
providing a core defining a slot;
applying a coating having a thermal conductivity of at least about 0.3 W·m⁻¹·K⁻¹ to at least a portion of a magnet body; and
inserting the magnet body into the slot with the coating being in a partially cured condition when the magnet body is inserted into the slot.

2. The method of claim 1 wherein the coating has a thermal conductivity of at least about 0.5 W·m⁻¹·K⁻¹.

3. The method of claim 1 wherein the coating has a thermal conductivity of at least about 2 W·m⁻¹·K⁻¹.

4. The method of claim 1 wherein the coating has a thermal conductivity of at least about 3 W·m⁻¹·K⁻¹.

5. The method of claim 1 wherein the magnet body defines at least one major surface and the coating forms a substantially voidless material bridge between the at least one major surface and the core and thereby thermally couples the magnet body with the core.

6. The method of claim 5 wherein the magnet body defines first and second major surfaces on opposing sides of the magnet body and wherein the coating forms a substantially voidless material bridge between the core and both of the first and second major surfaces.

7. The method of claim 1 further comprising the step of magnetizing the magnet body after inserting the magnet body into the slot wherein the step of magnetizing the magnet body includes biasing a first major surface of the magnet body toward a first slot surface defined by the core by magnetic attraction, the coating forming a substantially voidless material bridge between the first major surface and the slot surface to thereby thermally couple the magnet body with the core.

8. The method of claim 7 wherein the magnet body defines a second major surface opposite the first major surface and biasing the first major surface toward the first slot surface defines a layer between the second major surface and a second slot surface having a thermal conductivity less than the thermal conductivity of the substantially voidless material bridge and wherein the first major surface is disposed radially outwardly of the second major surface and wherein the method further comprises allowing the material bridge between the first major surface and the first slot surface to cure and thereby securely adhere the magnet body to the core.

9. The method of claim 1 further comprising heating the core and inserting the magnet body in the slot before allowing the core to cool and wherein the coating on the magnet body is heated to reflow the coating during the insertion of the magnet body and cooling of the core.

10. The method of claim 9 wherein the coating has a thermal conductivity of at least about 0.5 W·m⁻¹·K⁻¹.

11. The method of claim 9 wherein the coating has a thermal conductivity of at least about 2 W·m⁻¹·K⁻¹.

12. The method of claim 9 wherein the coating has a thermal conductivity of at least about 3 W·m⁻¹·K⁻¹.

13. The method of claim 9 wherein the coating is heated to reflow the coating by transferring heat from the core to the coating.

14. The method of claim 13 further comprising the step of forming the core out of a plurality of stacked laminations to define a rotor core having a central bore wherein the central bore and the at least one slot extend through the plurality of laminations; and wherein the method further includes installing a rotor hub in the central bore before allowing the rotor core to cool.

15. An electric machine comprising:
a stator assembly and a rotor assembly, at least one of the stator assembly and the rotor assembly including a core defining a slot;
a magnet body defining a first major surface being disposed in the slot;
a coating forming a substantially voidless material bridge between the first major surface of the magnet body and the core and wherein the coating has a thermal conductivity of at least about 0.3 W·m⁻¹·K⁻¹.

16. The electric machine of claim 15 wherein the coating has a thermal conductivity of at least about 0.5 W·m⁻¹·K⁻¹.

17. The electric machine of claim 15 wherein the coating has a thermal conductivity of at least about 2 W·m⁻¹·K⁻¹.

18. The electric machine of claim 15 wherein the coating has a thermal conductivity of at least about 3 W·m⁻¹·K⁻¹.

19. The electric machine of claim 15 wherein the core is a rotor core and defines a plurality of slots, each of the slots having a respective magnet body disposed therein wherein each magnet body defines first and second major surfaces on opposing sides of the magnet body and wherein the coating forms a substantially voidless material bridge between the core and each of the first and second surfaces of each of the magnet bodies.

20. The electric machine of claim 15 wherein the core is a rotor core and defines a plurality of slots, each of the slots having a respective magnet body disposed therein wherein each magnet body defines first and second major surfaces on opposing sides of the magnet body and wherein for each of the magnet bodies the first major surface is disposed radially outwardly of the second major surface with the coating forming a substantially voidless material bridge between the core and the first major surface with the material bridge adhesively securing the first major surface to the core and wherein a layer having a thermal conductivity less than the thermal conductivity of the substantially voidless material bridge is disposed between the second major surface and the core.
